(19) United States
(12) Patent Application Publication
(10) Pub. No.: US 2025/0263570 A1
(43) Pub. Date: Aug. 21, 2025

(54) Ink Jet Ink Composition, Recording Method, And Recording Device

(71) Applicant: SEIKO EPSON CORPORATION, Tokyo (JP)

(72) Inventors: Kentaro HARA, Shiojiri (JP); Jun ITO, Shimosuwa (JP)

(21) Appl. No.: 19/056,026

(22) Filed: Feb. 18, 2025

(30) Foreign Application Priority Data
Feb. 19, 2024 (JP) 2024-023064

(51) Int. Cl. C09D 11/38; B41J 2/155; C09D 11/033; C09D 11/102

(52) U.S. Cl. CPC C09D 11/38; C09D 11/033; C09D 11/102; B41J 2/155

(57) ABSTRACT

An ink jet ink composition includes a pigment; an acetylene glycol-based surfactant having an HLB value of 5 or less; a lactam compound having a 6- to 8-membered lactam ring; a solvent component; and a water-soluble resin dissolved in the solvent component, in which the content of the water-soluble resin is 0.3% by mass or more based on the total mass of the ink jet ink composition, the solvent component includes water, and the ink jet ink composition is an aqueous ink.

The present application is based on, and claims priority from JP Application Serial Number 2024-023064, filed Feb. 19, 2024, the disclosure of which is hereby incorporated by reference herein in its entirety.

### BACKGROUND

### 1. Technical Field

The present disclosure relates to an ink jet ink composition, a recording method, and a recording device.

### 2. Related Art

Ink jet recording methods are capable of recording a highly fine image with a relatively simple device, and have been rapidly developed in various aspects. During the development, various studies have been made on ejection reliability when recording is performed using an ink composition. For example, JP-A-2015-061896 discloses an ink composition which contains a self-dispersing pigment, a resin, and an organic solvent and which is used in an ink container having a predetermined ink chamber and a predetermined ink filling port for the purpose of providing an ink composition capable of suppressing generation of aggregates in the ink container.

When a recording medium is transported, discharged, and stacked in the inside of a recording device before an aqueous ink composition is sufficiently dried, the ink is likely to be transferred. On the other hand, in a case of attempting to prevent such ink transfer, there is a concern that ink ejection reliability decreases or compatibility with other components in the ink deteriorates.

### SUMMARY

An ink jet ink composition according to an aspect of the present disclosure includes a pigment, an acetylene glycol-based surfactant having an HLB value of 5 or less, a lactam compound having a 6- to 8-membered lactam ring, a solvent component, and a water-soluble resin dissolved in the solvent component, in which the content of the water-soluble resin is 0.3% by mass or more based on the total mass of the ink jet ink composition, the solvent component includes water, and the ink jet ink composition is an aqueous ink.

A recording method according to an aspect of the present disclosure includes ejecting the above-described ink jet ink composition from an ink jet head to deposit the ink jet ink composition on a recording medium.

A recording device according to an aspect of the present disclosure includes the above-described ink jet ink composition and an ink jet head configured to eject the ink jet ink composition.

### BRIEF DESCRIPTION OF THE DRAWINGS

FIG. 1 is Table 1 showing compositions of ink compositions used in examples and evaluation results thereof.

FIG. 2 is Table 2 showing compositions of ink compositions used in the examples and evaluation results thereof.

FIG. 3 is Table 3 showing compositions of ink compositions used in the examples and evaluation results thereof.

FIG. 4 is Table 4 showing compositions of ink compositions used in the examples and evaluation results thereof.

FIG. 5 is a diagram of one example of an ink jet recording device used in an ink jet recording method of an embodiment.

FIG. 6 is a diagram illustrating one example of a continuous ink supply container as an ink housing body.

FIG. 7 is a diagram illustrating one example of an ink cartridge as the ink housing body.

FIG. 8 is a diagram illustrating one example of an ink bottle as the ink housing body.

### DESCRIPTION OF EMBODIMENTS

Hereinafter, an embodiment of the present disclosure (hereinafter, referred to as “the present embodiment”) will be described in detail with reference to drawings as necessary. However, the present disclosure is not limited thereto, and various modifications can be made without departing from the spirit of the present disclosure. In the drawings, the same elements are denoted by the same reference numerals, and a repetitive description will be omitted. The positional relationships such as up, down, left, and right are based on the positional relationships illustrated in the drawings unless otherwise specified. Further, the dimensional ratios in the drawings are not limited to the ratios shown in the drawings.

### 1. Ink Jet Ink Composition

An ink jet ink composition (hereinafter, simply referred to as “the ink composition”) according to the present embodiment includes a pigment, an acetylene glycol-based surfactant having an HLB value of 5 or less, a lactam compound having a 6- to 8-membered lactam ring, a solvent component, and a water-soluble resin dissolved in the solvent component, in which the content of the water-soluble resin is 0.3% by mass or more based on the total mass of the ink jet ink composition, the solvent component includes water, and the ink jet ink composition is an aqueous ink.

In a case where recording is performed using an aqueous ink composition, when a recording medium is transported and discharged by a transporting roller immediately after the ink composition is deposited on the recording medium, the following problem arises: the undried ink composition adheres to the transporting roller or adheres to a contact surface of a recorded material discharged immediately before or after, causing ink transfer. Such transfer is considered to be caused by insufficient permeation of the ink composition into the recording medium. Therefore, as one measure for suppressing transfer, improvement of ink permeability is desired. When the ink promptly permeates into the recording medium, the ink permeates into the recording medium before the recording medium comes into contact with the transporting roller or another recording medium, thereby suppressing transfer.

Even when the ink composition sufficiently permeates and is absorbed into the recording medium, it is considered that the ink is still transferred to a roller or another recording medium in the recording device before drying. In this regard, it is considered that ink transfer is suppressed by adding resin particles as a fixing resin to the ink composition to obtain ink fixability. However, such a resin easily aggregates at a gas-liquid interface and easily forms foreign matter when the ink composition is stored in an ink container, and a problem of ejection reliability newly arises. Therefore, as a measure for suppressing transfer without deteriorating ejection reliability, use of a component in place of such a resin is desirable. In addition, transfer occurs early after the ink is deposited on a recording medium and occurs in a state where the ink is not sufficiently dried. Therefore, it is considered effective to suppress transfer even before the deposited ink is sufficiently dried by forming a coating film on the surface of the recording medium on which the ink is deposited in an early stage after the ink is deposited on the recording medium in a state in which the ink deposited on the recording medium is not sufficiently dried.

In the present embodiment, in order to improve the permeability of the ink, the acetylene glycol-based surfactant having an HLB value of 5 or less is used as a component for improving permeability. Then, by using a water-soluble resin that hardly forms foreign matter at a gas-liquid interface, it is possible to suppress transfer by forming a film on a surface of a recording medium at an early stage without deteriorating ejection reliability. The acetylene glycol-based surfactant having an HLB value of 5 or less, which improves ink permeability, tends to undergo phase separation in the ink composition and tends to decrease ejection stability. Therefore, the lactam compound having a 6- to 8-membered lactam ring is used together. Consequently, phase separation is suppressed, and ejection reliability is excellent. In this manner, an ink composition excellent in ejection reliability, transfer resistance, and compatibility can be provided.

The ink composition of the present embodiment is considered to have excellent ejection reliability, transfer resistance, and compatibility as a result of a synergistic effect provided by using the above components together. However, the cause therefor is not limited to the above.

The ink jet ink composition of the present embodiment is ejected by an ink jet recording device when used. In the ink jet recording device, an ink tank to which the ink composition is supplied or an ink housing body supplying the ink composition to the ink jet recording device preferably has a structure in which an ink liquid surface, which is a gas-liquid interface between the ink composition and gas, is formed. As described above, the problem related to, in particular, ejection reliability easily arises when a gas-liquid interface is present. Therefore, when such an ink tank or ink housing body is used, the effect of the present disclosure becomes more effective.

Although the ink tank is not particularly limited, examples thereof include a tank which is provided in a recording device and to which the ink jet ink composition is supplied, such as a continuous ink supply container, a sub-tank, and the like.

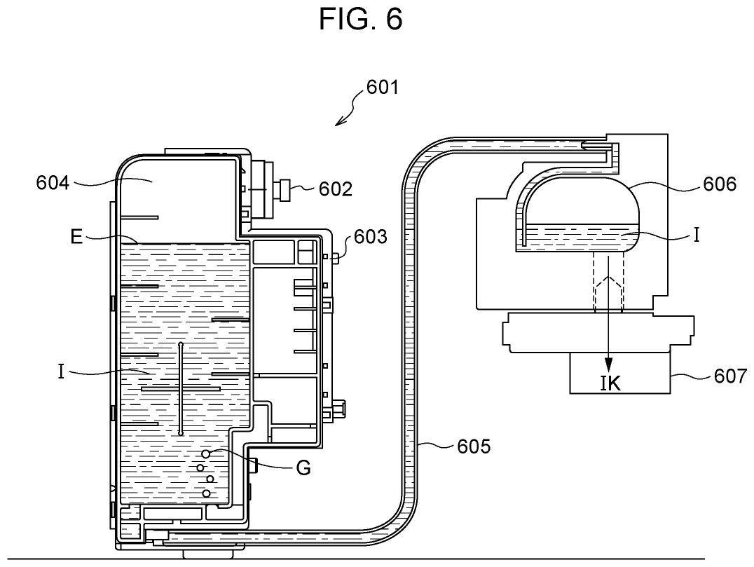

FIG. 6 shows one example of a configuration of a continuous ink supply container and a sub-tank. Incidentally, although the configuration of the continuous ink supply container and the sub-tank is collectively shown in FIG. 6, the recording device may have at least one of the sub-tank and the continuous ink supply container. The continuous ink supply container is one type of ink tanks and thus is a continuous ink supply tank. As shown in FIG. 6, a continuous ink supply container 601 includes an ink housing chamber 604 having an ink supply port 602 and an air supply port 603. Air supplied from the air supply port 603 is supplied as air G from a lower portion of the ink housing chamber 604, moves upward inside the ink housing chamber 604, and is supplied to an air layer K above a layer of ink I inside the ink housing chamber 604 to constitute part of the air layer.

The continuous ink supply container 601 has a configuration into which the ink composition is poured (replenished), enabling continuous printing, and an ink liquid surface E (gas-liquid interface) is formed inside the container in a state where the ink fills the continuous ink supply container. The ink liquid surface is an interface between the layer of ink (ink layer) and the air layer present above the ink layer in the ink tank or the ink housing body and is a horizontal surface. The ink liquid surface has a predetermined area. When the recording device has the continuous ink supply container, decrease of the ink in the continuous ink supply container to a predetermined amount or less can be prevented by supplying the ink to the continuous ink supply container through the ink supply port 602, enabling continuous printing. The ink may be supplied through the ink supply port 602 from an ink bottle described later, for example. When the recording device has the continuous ink supply container, the recording device may include no sub-tank, and the ink may be directly supplied to an ink jet head from an ink flow path 605.

As shown in FIG. 6, the sub-tank 606 is a relay tank for the ink composition provided inside the recording device. The sub-tank 606 may be connected to the continuous ink supply container 601 via the ink flow path 605. When the recording device has the sub-tank, printing can continue for a while using the ink in the sub-tank even when the ink supply to the sub-tank is interrupted for a while. The ink may be supplied to the sub-tank from the continuous ink supply container as shown in FIG. 6 or from an ink cartridge described later. When the ink is supplied from an ink cartridge, the recording device has an ink supply mechanism (ink cartridge mounting mechanism) not shown in the drawing, the ink cartridge is mounted on the ink supply mechanism, and the ink is supplied to the sub-tank via the ink supply mechanism and an ink flow path from the ink cartridge. In this case, the recording device has no continuous ink supply container.

The height of the sub-tank 606 also can generate an ink pressure to supply the ink composition to an ink jet head 607. The direction in which the ink is supplied to the ink jet head is denoted by IK. The sub-tank has a higher degree of freedom regarding the placement position than the continuous ink supply container, is easily disposed at a position at which the ink composition is easily supplied to the ink jet head 607, and thus is preferable. An ink liquid surface (gas-liquid interface) is similarly formed at the interface between the layer of the ink I inside the sub-tank and the air layer above the layer of the ink I as illustrated in FIG. 6, also in the sub-tank 606 as described above.

The ink may be supplied from the ink tank to the ink jet head by generating an ink pressure based on the relationship between the ink jet head and the height of the ink liquid surface in the ink tank or by generating an ink pressure using an ink pump (not shown), for example. The same also applies to ink supply from the continuous ink supply container to the sub-tank when the recording device has the sub-tank and the continuous ink supply container.

Although the ink housing body is not particularly limited, examples thereof include one supplying the ink jet ink composition to a structure included in the recording device, such as an ink cartridge or an ink bottle.

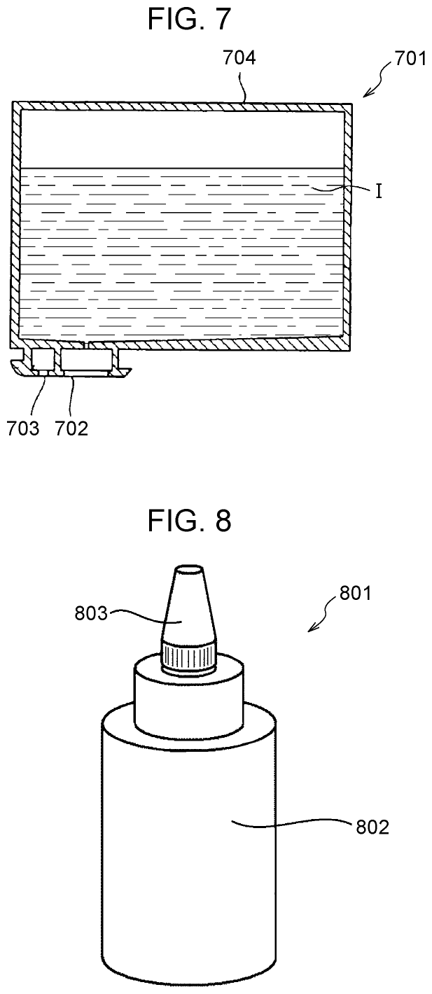

FIG. 7 shows one example of a configuration of an ink cartridge. As shown in FIG. 7, an ink cartridge 701 is mounted on an ink supply mechanism (not shown) of the recording device when used, and includes a housing chamber 704 having an ink supply port 702 and an air communication port 703. When the ink composition is used, and the ink I inside the housing chamber 704 is decreased, air is supplied through the air communication port 703, an air layer is formed, and an ink liquid surface (gas-liquid interface) is formed inside the housing chamber 704. Incidentally, an ink cartridge free of foam is preferable, and a non-packed ink cartridge is preferable.

FIG. 8 shows one example of a configuration of an ink bottle. As shown in FIG. 8, an ink bottle 801 includes a container main body 802 capable of housing the ink composition and an ink replenishing port 803 mounted on the tip end side of the container main body 802. Although not particularly limited, the ink replenishing port 803 of the ink bottle 801 is inserted into the ink supply port 602 of the continuous ink supply container, and the ink composition housed in the ink bottle 801 can be supplied to the continuous ink supply container, for example. An ink liquid surface is formed at the interface between an ink layer (not shown) and an air layer above the ink layer inside the ink bottle.

As described above, when the ink tank, the ink housing body, or the like has the ink liquid surface, the maximum area of the ink liquid surface is preferably 400 mm² or more, more preferably 500 mm² or more, still more preferably 600 mm² or more, and particularly preferably 700 mm² or more. In addition, the upper limit value of the maximum area of the ink liquid surface depends on the size of the recording device and the like and is not particularly limited, but may be, for example, 1000 mm² or less. When the maximum area of the ink liquid surface falls within the above ranges, the effect of the present disclosure becomes more effective. Incidentally, the maximum area of the ink liquid surface is the maximum cross-sectional area among horizontal cross-sections in the part in which the ink is housed such as the ink tank and the ink housing body.

Hereinafter, components constituting the ink composition of the present embodiment will be described in detail.

### 1. 1. Pigment

The ink composition includes a pigment. Examples of the pigment include a self-dispersing pigment dispersed by introducing a hydrophilic functional group into a surface of the pigment utilizing chemical reaction on pigment particle surfaces to impart dispersion stability to the pigment. The hydrophilic functional group includes a carboxy group, a phosphorus-containing group such as a phosphonic acid group, and sulfo group. The pigment includes a resin-dispersed pigment obtained by using a dispersant resin, which is a resin. The dispersant resin is attached or adsorbed to a surface of the pigment, dispersion stability is thereby imparted to the pigment, and the resin-dispersed pigment is thus dispersed. The self-dispersing pigment is preferably included from the viewpoint of improving ejection reliability, transfer resistance, and compatibility. The self-dispersing pigment does not require a dispersant such as a dispersant resin for dispersing the pigment, and the self-dispersing pigment is preferable because the viscosity of the ink can be relatively kept low even when the content of the pigment in the ink is increased, and ejection stability and chromogenic properties are excellent. One kind of the pigment may be used singly, or two or more kinds thereof may be used in combination.

Examples of the self-dispersing pigment include organic pigments such as an azo pigment (including azo lake, an insoluble azo pigment, a condensed azo pigment, a chelate azo pigment, and the like), a polycyclic pigment (a phthalocyanine pigment, a perylene pigment, a perinone pigment, an anthraquinone pigment, a quinacridone pigment, a dioxazine pigment, a thioindigo pigment, an isoindolinone pigment, a quinophthalone pigment, and the like), a nitro pigment, a nitroso pigment, and aniline black; inorganic pigments such as carbon black (furnace black, thermal lamp black, acetylene black, channel black, and the like), a metal oxide, a metal sulfide, and a metal chloride; and extender pigments such as silica, calcium carbonate, and talc. Among them, carbon black is preferably used as the pigment from the viewpoint of reliably providing the effect of the present disclosure more effectively.

The content of the pigment is preferably 1.0% by mass or more and 15% by mass or less, 3.0% by mass or more and 10% by mass or less, or 5.0% by mass or more and 8.0% by mass or less based on the total amount of the ink composition. When the content of the pigment falls within the above ranges, the effect of the present disclosure tends to be reliably provided more effectively.

### 1. 2. Acetylene Glycol-Based Surfactant

The ink composition includes an acetylene glycol-based surfactant having an HLB value of 5 or less. When the acetylene glycol-based surfactant having an HLB value of 5 or less (hereinafter, also simply referred to as the “acetylene glycol-based surfactant,” and the acetylene glycol-based surfactant without reference to the HLB value means that the HLB value thereof is 5 or less unless otherwise specified) is included, permeability of the ink is improved and transfer resistance is excellent. In addition, ejection characteristics of the ink are improved, and ejection reliability and ejection stability are also improved. On the other hand, the acetylene glycol-based surfactant has low water solubility and tends to cause phase separation in the ink composition, and compatibility tends to decrease. From the same viewpoint, the HLB value of the acetylene glycol-based surfactant included in the ink composition is preferably 4 or less. A lower limit is 0 or more and is preferably 1 or more and more preferably 2 or more, but is not limited thereto. One kind of the acetylene glycol-based surfactant may be used singly, or two or more kinds thereof may be used in combination.

As the acetylene glycol-based surfactant included in the ink composition, the acetylene glycol-based surfactant having an HLB value of 5 or less and an acetylene glycol-based surfactant having an HLB value exceeding 5 are preferably included, the acetylene glycol-based surfactant having an HLB value of 5 or less and an acetylene glycol-based surfactant having an HLB value of 7 or more are more preferably included, and the acetylene glycol-based surfactant having an HLB value of 5 or less and an acetylene glycol-based surfactant having an HLB value of 10 or more are still more preferably included. An upper limit of the HLB value is 20 or less and preferably 15 or less. Among acetylene glycol-based surfactants, the acetylene glycol-based surfactant having an HLB value of 5 or less tends to relatively improve permeability of the ink more significantly compared to the acetylene glycol-based surfactant having an HLB value exceeding 5 but tends to easily cause phase separation in the ink composition. Therefore, the case where the acetylene glycol-based surfactant having an HLB value of 5 or less and the acetylene glycol-based surfactant having an HLB value exceeding 5 are included is preferable because the content of the acetylene glycol-based surfactant in ink can be increased, and ejection characteristics, permeability, and suppression of phase separation can be enhanced.

In the present specification, “hydrophilic lipophilic balance (HLB) value” is a value calculated by the Griffin method. Specifically, the HLB value of a surfactant can be calculated according to the following formula (H).

HLB value=20×(mass % of hydrophilic group) (H):

Examples of commercially available products of the acetylene glycol-based surfactant include SURFYNOL 104 (HLB=4), SURFYNOL 420 (HLB value=4), SURFYNOL 82 (HLB value=4), SURFYNOL DF110D (HLB value=3), SURFYNOL 104S (HLB value=4), SURFYNOL 104PG50 (HLB value=4), SURFYNOL 420 (HLB value=4), SURFYNOL 82 (HLB value=4), and SURFYNOL MD-20 (HLB value=4) (which are all product names, manufactured by Nissin Chemical Industry Co., Ltd.). From the viewpoint of reliably providing the effect of the present disclosure more effectively, the ink composition preferably includes SURFYNOL 104PG50 or SURFYNOL 420.

Specific compounds of the acetylene glycol-based surfactant include, for example, 2,5,8,11-tetramethyl-6-dodecyne-5,8-diol or an alkylene oxide adduct thereof, 5,8-dimethyl-6-dodecyne-5,8-diol or an alkylene oxide adduct thereof, 2,4,7,9-tetramethyl-5-decyne-4,7-diol or an alkylene oxide adduct thereof, and 4,7-dimethyl-5-decyne-4,7-diol or an alkylene oxide adduct thereof.

The content of the acetylene glycol-based surfactant is preferably 0.01% by mass or more and 3.0% by mass or less, 0.05% by mass or more and 1.0% by mass or less, or 0.1% by mass or more and 0.8% by mass or less based on the total amount of the ink composition. When the content of the acetylene glycol-based surfactant falls within the above ranges, transfer resistance, ejection reliability, and ejection stability tend to be more improved. The content of the acetylene glycol-based surfactant having an HLB value of 5 or less may fall within the above ranges, and the content of the acetylene glycol-based surfactant having an HLB value of 5 or less falling within the above ranges is preferable from the above points. Further, the content of the acetylene glycol-based surfactant having an HLB value of 5 or less is preferably 0.1% by mass or more and 0.5% by mass or less, more preferably 0.1% by mass or more and 0.4% by mass or less, and still more preferably 0.1% by mass or more and 0.3% by mass or less.

The ink composition of the present embodiment may include an additional surfactant in addition to the acetylene glycol-based surfactant. Examples of the additional surfactant include a fluorine-based surfactant and a silicone-based surfactant. Examples of the fluorine-based surfactant include a perfluoroalkyl sulfonate, a perfluoroalkyl carboxylate, a perfluoroalkyl phosphoric acid ester, and a perfluoroalkyl ethylene oxide adduct. Examples of the silicone-based surfactant include a polysiloxane-based compound and a polyether-modified organosiloxane.

The content of the additional surfactant is not particularly limited as long as the effect of the present disclosure is not impaired and is, for example, 0% by mass or more and 3% by mass or less, 0% by mass or more and 1% by mass or less, or 0% by mass or more and 0.1% by mass or less based on the total amount of the ink composition.

### 1. 3. Lactam Compound

The ink composition includes a 6- to 8-membered lactam compound. The lactam compound has a structure in which a ring is formed through dehydration-condensation reaction of a carboxy group and an amino group in a molecule. When the ink composition includes the 6- to 8-membered lactam compound, transfer resistance, ejection reliability, and ejection stability are improved. From the same viewpoint, the ink composition preferably includes a 6- or 7-membered lactam compound and more preferably includes a 7-membered lactam compound. Note that a lactam compound having an n-membered ring means that the number of atoms constituting the ring is n. One kind of the lactam compound may be used singly, or two or more kinds thereof may be used in combination.

Specific examples of the 6- to 8-membered lactam compound include ε-caprolactam, δ-valerolactam, ω-heptalactam, and 5-(methylamino) pentanoic acid lactam, and ε-caprolactam is preferably included. When the ink composition includes ε-caprolactam, transfer resistance, ejection reliability, and ejection stability tend to be more improved.

In the ink composition, the mass ratio (A/B) of the content A of the acetylene glycol-based surfactant having an HLB value of 5 or less to the content B of the lactam compound is preferably 0.01 or more and 0.7 or less, 0.02 or more and 0.6 or less, and 0.03 or more and 0.5 or less. Further, the mass ratio (A/B) is preferably 0.05 to 0.4 and more preferably 0.1 to 0.3. When the mass ratio (A/B) falls within the above ranges, transfer resistance, ejection reliability, and ejection stability tend to be more improved.

The content of the 6- to 8-membered ring lactam compound is preferably 0.1% by mass or more and 15% by mass or less, 0.5% by mass or more and 10% by mass or less, and 1.0% by mass or more and 8.0% by mass or less based on the total amount of the ink composition. Furthermore, the content of the 6- to 8-membered ring lactam compound is preferably 2.0% to 5.0% by mass and more preferably 2.0% to 3.0% by mass. When the content of the 6- to 8-membered ring lactam compound falls within the above ranges, transfer resistance, ejection reliability, and ejection stability tend to be more improved.

### 1. 4. Water-Soluble Resin

The ink composition includes a water-soluble resin dissolved in a solvent component. When the water-soluble resin is included, transfer resistance, ejection reliability, and ejection stability are improved. Examples of the water-soluble resin include a urethane-based resin, an acrylic resin, a polyalkylene oxide-based resin, a polyvinyl alcohol-based resin, and a carboxymethyl cellulose-based resin. Among them, from the viewpoint of further improving transfer resistance, ejection reliability, and ejection stability, as the water-soluble resin, a urethane-based resin or an acrylic resin is preferably included, and a urethane resin is more preferably included. One kind of the water-soluble resin may be used singly, or two or more kinds thereof may be used in combination.

In the ink, the water-soluble resin used in the present embodiment is a water-soluble resin dissolved in a solvent component of the ink including water, and is not a resin attached or adsorbed to the pigment. Further, the water-soluble resin is not a dispersant resin for dispersing an ink component such as the pigment. The water-soluble resin is a resin that shows no undissolved residue or overall cloudiness in a mixture liquid when the resin is mixed into water at normal temperature of 25° C. at a concentration of 1% by mass and stirred, for example.

The urethane-based resin is not particularly limited as long as it is a water-soluble resin having a urethane bond in within the molecule thereof, and examples thereof include a resin having a repeating unit derived from a polyisocyanate and a polyol.

Examples of the polyisocyanate include aliphatic polyisocyanates such as tetramethylene diisocyanate, dodecamethylene diisocyanate, hexamethylene diisocyanate, 2,2,4-trimethylhexamethylene diisocyanate, and 2,4,4-trimethylhexamethylene diisocyanate; alicyclic polyisocyanates such as isophorone diisocyanate, dicyclohexylmethane-4,4-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, and 2,5- or 2,6-norbornane diisocyanate; and aromatic polyisocyanates such as tolylene diisocyanate, 2,2′-diphenylmethane diisocyanate, 2,4′-diphenylmethane diisocyanate, 4,4′-diphenylmethane diisocyanate, 4,4′-dibenzyl diisocyanate, 1,5-naphthylene diisocyanate, xylylene diisocyanate, and 1,3-phenylene diisocyanate.

Examples of the polyol include polyether polyols such as polyethylene glycol and polypropylene glycol, polyester polyols, and polycarbonate polyols, which have no acid group, and also include polyols having a carboxylic acid group, a sulfonic acid group, a phosphoric acid group, a phosphonic acid group, or the like as an acid group.

The acrylic resin is not particularly limited as long as it is a water-soluble resin obtained by polymerizing, as one component, an acrylic monomer such as (meth)acrylic acid or a (meth)acrylic acid ester. Note that the term “(meth)acrylic” means a concept including both “methacrylic” and “acrylic.” The (meth)acrylic resin is not particularly limited, and examples thereof include a polymer of a (meth)acrylic monomer such as (meth)acrylic acid or a (meth)acrylic acid ester, and a copolymer of a (meth)acrylic monomer and another monomer. From the viewpoint of reliably providing the effect of the present disclosure more effectively, a styrene-acrylic resin is preferably used as the water-soluble resin.

As the urethane-based resin and the acrylic resin of the present embodiment, resins obtained by the method described in examples described later are preferably used. According to such a method, the effect of the present disclosure can be reliably provided more effectively.

The acid value of the water-soluble resin is preferably 40 to 100 mg KOH/g, 40 to 90 mg KOH/g, 45 to 80 mg KOH/g, or 50 to 70 mg KOH/g. When the acid value of the urethane resin falls within the above ranges, transfer resistance, ejection reliability, and ejection stability tend to be more improved. The acid value may be determined by a potentiometric titration method.

The weight average molecular weight of the water-soluble resin is preferably 5000 to 150000, 10000 to 100000, 15000 to 50000, or 20000 to 30000. When the weight average molecular weight of the water-soluble resin falls within the above ranges, transfer resistance, ejection reliability, and ejection stability tend to be more improved. The weight average molecular weight may be determined by a GPC method.

The content of the water-soluble resin is 0.3% by mass or more, preferably 0.3% by mass or more and 3.0% by mass or less, 0.3% by mass or more and 2.0% by mass or less, or 0.3% by mass or more and 0.8% by mass or less based on the total amount of the ink composition. When the content of the water-soluble resin falls within the above ranges, transfer resistance, ejection reliability, and ejection stability tend to be more improved.

### 1. 5. Resin Particles

The ink composition is preferably free of resin particles. Resin particles include a form of a resin emulsion and the like. The resin particles are in a state in which a water-insoluble resin is dispersed in ink. The resin particles are not particularly limited as long as the resin particles are not formed from a water-soluble resin, and examples thereof include resin particles formed from a urethane-based resin, an acrylic resin, a fluorene-based resin, a polyolefin-based resin, a rosin-modified resin, a terpene-based resin, a polyester-based resin, a polyamide-based resin, an epoxy-based resins, a vinyl chloride-based resin, or an ethylene vinyl acetate-based resin.

The content of the resin particles in the ink composition is preferably less than 0.1% by mass, more preferably less than 0.05% by mass, and still more preferably 0.00% by mass based on the total amount of the ink composition. When the content of the resin particles falls within the above ranges, the effect of the present disclosure can be reliably provided more effectively.

### 1. 6. Solvent Component

The ink composition is an aqueous ink, includes water as the solvent component, and may further include an organic solvent.

### 1. 6. 1. Water

Ionic impurities are preferably removed from water as much as possible, and although such water is not particularly limited, examples thereof include pure water such as ion-exchanged water, ultrafiltration water, reverse osmosis water, and distilled water, and ultrapure water.

The content of water is preferably 55% to 99% by mass, more preferably 60% to 90% by mass, and still more preferably 65% to 80% by mass based on the total amount of the ink composition.

### 1. 6. 2. Water-Soluble Organic Solvent

The ink composition preferably includes a water-soluble organic solvent as the solvent component. When the water-soluble organic solvent is included, transfer resistance and ejection stability of the ink composition tend to be excellent, and evaporation of moisture during storage tends to be suppressed. Examples of the water-soluble organic solvent include polyhydric alcohols, glycol ethers, nitrogen-containing solvents, esters, and cyclic esters. Among them, a polyhydric alcohol is preferably included as the water-soluble organic solvent.

The polyhydric alcohol has two or more hydroxy groups in a molecule, and examples thereof include polyols and alkanediols.

Specific compounds of the polyols include ethylene glycol, propylene glycol, 1,2-propanediol, 1,2-butanediol, 1,3-propanediol, 1,4-butanediol, diethylene glycol, triethylene glycol, dipropylene glycol, trimethylolpropane, and glycerin, for example. The polyols include a compound having three or more hydroxy groups in a molecule, a compound having an ether group in a skeleton (an intermolecular condensation product of an alkanediol), and an alkanediol having 4 or less carbon atoms. Among them, glycerin or triethylene glycol is preferably used from the viewpoint of reliably providing the effect of the present disclosure more effectively.

The ink composition preferably includes an alkanediol compound having 5 or more carbon atoms as the water-soluble organic solvent. When the alkanediol compound having 5 or more carbon atoms is included, transfer resistance, ejection reliability, and ejection stability tend to be more improved. The upper limit of the number of carbon atoms is not particularly limited, but is, for example, 15 or less, 12 or less, or 10 or less. The alkanediol compound is preferably a 1,2-alkanediol.

Specific compounds of alkanediols include 1,2-hexanediol, 1,2-pentanediol, 1,2-octanediol, 1,6-hexanediol, 2-methyl-2,4-pentanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, and 2-methylpentane-2,4-diol, for example. Among them, 1,2-hexanediol is preferably included from the viewpoint of further improving transfer resistance, ejection reliability, and ejection stability.

Among them, the ink composition preferably includes a polyol having a standard boiling point of 280° C. or higher, such as glycerin, as the water-soluble organic solvent. When a polyol having a standard boiling point of 280° C. or higher is included, transfer resistance, ejection reliability, and ejection stability tend to be more improved. The content of the polyol having a standard boiling point of 280° C. or higher in the ink is preferably 0.5% to 10% by mass, more preferably 1.0% to 7.0% by mass, still more preferably 2.0% to 6.0% by mass, and particularly preferably 3.0% to 6.0% by mass. The content of the polyhydric alcohol including the polyol having a standard boiling point of 280° C. or higher in the ink may be set to fall within the above ranges.

The content of the water-soluble organic solvent is preferably 5.0% by mass or more and 40% by mass or less, 10% by mass or more and 30% by mass or less, 11% by mass or more and 25% by mass or less, or 12% by mass or more and 20% by mass or less based the total amount of the ink composition. When the content of the water-soluble organic solvent falls within the above ranges, the effect of the present disclosure tends to be reliably provided more effectively.

The content of the polyol is preferably 5.0% by mass or more and 30% by mass or less, 10% by mass or more and 20% by mass or less, or 12% by mass or more and 15% by mass or less based on the total amount of the ink composition. When the content of the polyol falls within such ranges, the effect of the present disclosure tends to be reliably provided more effectively.

The content of the alkanediol is preferably 1.0% by mass or more and 15% by mass or less, 2.0% by mass or more and 10% by mass or less, or 3.0% by mass or more and 7.0% by mass or less based on the total amount of the ink composition. When the content of the alkanediol falls within such ranges, the effect of the present disclosure tends to be reliably provided more effectively.

### 1. 7. Inorganic Oxide Particles

The ink composition may include inorganic oxide particles. The inorganic oxide particles mean fine particles of an inorganic oxide dispersed in a dispersion medium. When the inorganic oxide particles are included, curling of recording media tends to be suppressed in general. One kind of the inorganic oxide particles may be used singly, or two or more kinds thereof may be used in combination.

Examples of the inorganic oxide particles include, but are not particularly limited to, metal oxides such as silica, alumina, titania, zirconia, antimony oxide, tin oxide, tantalum oxide, zinc oxide, cerium oxide, lead oxide, and indium oxide; metal nitrides such as silicon nitride, titanium nitride, and aluminum nitride; metal carbides such as silicon carbide and titanium carbide; metal sulfides such as zinc sulfide; metal carbonates such as calcium carbonate and magnesium carbonate; metal sulfates such as calcium sulfate and magnesium sulfate; metal silicates such as calcium silicate and magnesium silicate; metal phosphates such as calcium phosphate; metal borates such as aluminum borate and magnesium borate; and composites thereof. From the viewpoint of reliably providing the effect of the present disclosure more effectively, silica is preferable. The inorganic oxide particles may form a salt.

The content of the inorganic oxide particles is preferably less than 0.1% by mass, more preferably less than 0.05% by mass, and still more preferably 0.00% by mass based on the total amount of the ink composition. When the content of the inorganic oxide particles is within the above ranges, the effect of the present disclosure tends to be reliably provided more effectively. The inorganic oxide particles may not be included.

### 1. 8. Betaine

The term “betaine” refers to a compound having a positive charge and a negative charge at non-adjacent positions in the same molecule, in which a hydrogen atom capable of dissociating is not bonded to the atom having the positive charge, constituting an intramolecular salt, and the compound is not charged as a whole molecule. In the present embodiment, the betaine preferably has a quaternary ammonium cation as the positively charged moiety.

When the ink composition includes the betaine, it is possible to prevent misdirection and ejection failure of the ink composition caused when the ink composition dries in a nozzle of an ink jet head, and ejection stability tends to be excellent.

The number of carbon atoms in a betaine compound is preferably 4 to 12, more preferably 4 to 7, and still more preferably 4 to 6. When the number of carbon atoms of the betaine falls within the above ranges, ejection stability tends to be more improved.

Although the betaine is not particularly limited, examples thereof include trimethylglycine, γ-butyrobetaine, homarine, trigonelline, carnitine, homoserine betaine, valine betaine, lysine betaine, ornithine betaine, alanine betaine, stachydrin, and glutamic acid betaine. Among them, trimethylglycine is preferable. Consequently, ejection stability tends to be more improved. One kind of the betaine may be used singly, or two or more kinds thereof may be used in combination.

The content of the betaine is preferably 0.0% by mass or more and 15% by mass or less, 1.0% by mass or more and 10% by mass or less, or 3.0% by mass or more and 8.0% by mass or less based on the total amount of the ink composition. When the content of the betaine falls within the above ranges, the effect of the present disclosure tends to be reliably provided more effectively.

### 1. 9. Other Components

The ink composition of the present embodiment may contain a component other than those described above, if needed. Examples of such a component include a pH modifier, a moistening agent, and a chelating agent.

Examples of the pH modifier include inorganic acids (such as sulfuric acid, hydrochloric acid, and nitric acid), inorganic bases (such as lithium hydroxide, sodium hydroxide, potassium hydroxide, and ammonia), organic bases (such as triethanolamine, diethanolamine, monoethanolamine, and tripropanolamine), and organic acids (such as adipic acid, citric acid, and succinic acid). Triethanolamine is preferable from the viewpoint of reliably providing the effect of the present disclosure more effectively.

The content of the pH modifier is preferably 0.01% by mass to 1.5% by mass, 0.05% by mass to 1.0% by mass, 0.1% by mass to 0.8% by mass, or 0.3% by mass to 0.7% by mass based on the total amount of the ink composition. When the content of the pH modifier falls within the above ranges, the effect of the present disclosure tends to be reliably provided more effectively.

### 2. Recording Medium

Although the recording medium used for recording with the ink composition of the present embodiment is not particularly limited, examples thereof include an absorptive recording medium, a low-absorptive recording medium, and a non-absorptive recording medium. Among them, an absorptive recording medium is preferable.

Although the absorptive recording medium is not particularly limited, examples thereof include regular paper such as electrophotographic paper, ink jet paper, and fabric, which have high ink permeability. Examples of the ink jet paper include exclusive paper for ink jet printing, provided with an ink absorptive layer composed of silica particles or alumina particles or with an ink absorptive layer composed of a hydrophilic polymer such as polyvinyl alcohol (PVA) or polyvinyl pyrrolidone (PVP).

Although the low-absorptive recording medium is not particularly limited, examples thereof include art paper, coated paper, and cast paper, which have relatively low ink permeability and are used for general offset printing. Although the non-absorptive recording medium is not particularly limited, examples thereof include films and plates of plastic such as polyvinyl chloride, polyethylene, polypropylene, polyethylene terephthalate (PET), polycarbonate, polystyrene, and polyurethane; plates of metal such as iron, silver, copper, and aluminum; metal plates produced through vapor deposition of such various kinds of metal, plastic films, and plates of alloy such as stainless steel and brass; and recording media in which a film of plastic such as polyvinyl chloride, polyethylene, polypropylene, polyethylene terephthalate (PET), polycarbonate, polystyrene, or polyurethane is adhered to (coats) a paper base material.

### 3. Ink Jet Recording Method

An ink jet recording method of the present embodiment includes an ejection step of ejecting the above-described ink composition from an ink jet head to deposit the ink composition on a recording medium and may include an additional step if needed. Examples of the additional step include a transporting step of transporting the recording medium.

In the ejection step, the ink composition is ejected from an ink jet head to deposit the ink composition on a recording medium. More specifically, the ink composition filling a pressure generation chamber of the ink jet head is ejected from a nozzle by driving a pressure generating unit provided inside the ink jet head. Such an ejection method is also referred to as an ink jet method.

The ink jet head used in the ejection step includes a line head for recording in a line method and a serial head for recording in a serial method, and the line head is preferably used. When the line head is used, recording speed is high, the time from deposition of ink on a recording medium to the contact thereof with the transporting roller or another recording medium is short, and the effect of the present disclosure is more effective.

In the line method using a line head, an ink jet head having a width equal to or more than the recording width of the recording medium is fixed to the recording device, for example. Then, the recording medium is moved along the scanning direction (recording medium transporting direction), and ink droplets are ejected from a nozzle of the ink jet head in conjunction with this movement to record an image on the recording medium. An image on one surface of one sheet of the recording medium is recorded by performing scanning once in which ink droplets are ejected from the nozzle while moving the recording medium as described above along the scanning direction.

In the serial method using a serial head, an ink jet head is mounted to a carriage capable of moving in the width direction of the recording medium, for example. Then, the carriage is moved along the main scanning direction (width direction of the recording medium), and ink droplets are ejected from a nozzle of the ink jet head in conjunction with this movement to record an image on the recording medium.

In the transporting step, the recording medium is transported in a predetermined direction inside the recording device. More specifically, the recording medium is transported from a paper feeder to a paper discharger of the recording device using a transporting roller or a transporting belt provided in the recording device. In the transporting process, the ink ejected from the ink jet head is deposited on the recording medium to form a recorded material. The transportation may be performed continuously or intermittently.

### 4. Ink Jet Recording Device

The ink jet recording device of the present embodiment has the above-described ink composition and an ink jet head configured to eject the above-described ink composition. The ink jet head includes a pressure chamber to which the ink is supplied and a nozzle configured to eject the ink. The ink jet recording device may further have a transporting unit that transports a recording medium. The transporting unit is composed of a transporting roller or a transporting belt provided inside the recording device.

The ink jet recording device may have either the continuous ink supply container shown in FIG. 6 or a sub-tank, may be configured such that the ink cartridge shown in FIG. 7 can be mounted, or may be configured such that the ink composition can be supplied from the ink bottle shown in FIG. 8. In these cases, foreign matter is prevented from forming at the ink liquid surface, and the effect of the present disclosure is more effective.

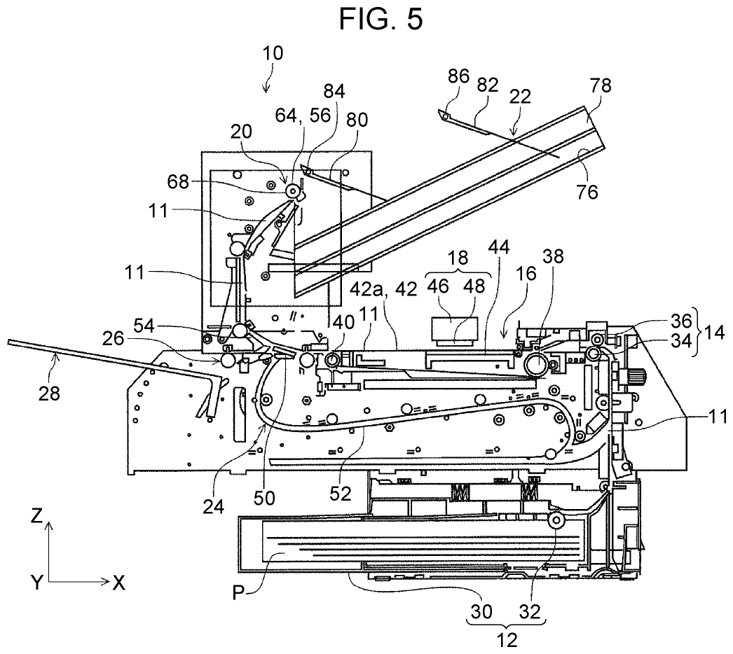

Hereinafter, the ink jet recording device according to the present embodiment will be described with reference to FIG. 5. Note that in the X-Y-Z coordinate system shown in FIG. 5, the X direction indicates the length direction of the recording medium, the Y direction indicates the width direction of the recording medium in a transport path in the recording device, and the Z direction indicates the device height direction.

A recording device 10 is, for example, a line-type ink jet printer capable of performing high-speed and high-density printing. The recording device 10 includes a feeder 12 that houses a recording medium P such as a paper sheet, a transporter 14, a belt transporter 16, a recorder 18, an Fd (face-down) discharger 20 as a “discharger,” an Fd (face-down) mounting section 22 as a “mounting section,” a reverse path section 24 as a “reverse transport mechanism,” an Fu (face-up) discharger 26, and an Fu (face-up) mounting section 28.

The feeder 12 is disposed in a lower portion of the recording device 10. The feeder 12 includes a feeding tray 30 that houses the recording medium P, and a feeding roller 32 that feeds the recording medium P housed in the feeding tray 30 to a transport path 11.

The recording medium P housed in the feeding tray 30 is fed to the transporter 14 along the transport path 11 by the feeding roller 32. The transporter 14 includes a transport driving roller 34 and a transport driven roller 36. The transport driving roller 34 is rotary driven by a driving source (not shown). In the transporter 14, the recording medium P is pinched (nipped) between the transport driving roller 34 and the transport driven roller 36 and transported to the belt transporter 16 positioned on the downstream side of the transport path 11.

The belt transporter 16 includes a first roller 38 positioned on the upstream side in the transport path 11, a second roller 40 positioned on the downstream side, an attached to the first roller 38 and the second roller 40 such that the endless belt 42 can rotary move, and a support 44 supporting an upper section 42a of the endless belt 42 between the first roller 38 and the second roller 40.

The endless belt 42 is driven so as to move from the +X direction to the −X direction in the upper section 42a by the first roller 38 or the second roller 40 driven by a driving source (not shown). Consequently, the recording medium P transported from the transporter 14 is further transported to the downstream side of the transport path 11 in the belt transporter 16.

The recorder 18 includes a line-type ink jet head 48 and a head holder 46 holding the ink jet head 48. Note that the recorder 18 may be a serial type recorder in which a carriage reciprocating in the Y-axis direction is provided with an ink jet head. The ink jet head 48 is disposed so as to face the upper section 42a of the endless belt 42 supported by the support 44. The ink jet head 48 ejects the ink toward the recording medium P when the recording medium P is transported in the upper section 42a of the endless belt 42, and recording is executed. The recording medium P is transported to the downstream side of the transport path 11 by the belt transporter 16 while performing recording.

Note that the “line-type ink jet head” is a head used for an ink jet recording device in which a nozzle region formed in a direction intersecting with the transport direction of the recording medium P is provided so as to be capable of covering the entire of the intersecting direction of the recording medium P, the ink jet recording device forming an image by moving one of the head or the recording medium P, while keeping the other fixed. Note that the nozzle region of the line head in the intersecting direction may not be capable of covering the entire of the intersecting direction of all types of the recording medium P supported by the ink jet recording device.

A first branch portion 50 is provided on the downstream side of the transport path 11 of the belt transporter 16. The first branch portion 50 is configured to be switchable between the transport path 11 in which the recording medium P is transported to the Fd discharger 20 or the Fu discharger 26, and a reverse path 52 of the reverse path section 24 in which the recording surface of the recording medium P is reversed and the recording medium P is transported to the recorder 18 again. Note that, the recording surface of the recording medium P which is transported after switching to the reverse path 52 is performed in the first branch portion 50 is reversed during the transport process in the reverse path 52 and transported to the recorder 18 again so that the surface opposite to the initial recording surface faces the ink jet head 48.

A second branch portion 54 is further provided on the downstream side of the first branch portion 50 along the transport path 11. The second branch portion 54 is configured to be capable of switching the transport direction of the recording medium P so that the recording medium P is transported toward the Fd discharger 20 or the recording medium P is transported toward the Fu discharger 26.

The recording medium P transported toward the Fd discharger 20 in the second branch portion 54 is discharged from the Fd discharger 20 and mounted on the Fd mounting section 22. At this time, the recording surface of the recording medium P is mounted so as to face the Fd mounting section 22. The recording medium P transported toward the Fu discharger 26 in the second branch portion 54 is discharged from the Fu discharger 26 and mounted on the Fu mounting section 28. At this time, the recording surface of the recording medium P is mounted so as to face the opposite side to the Fu mounting section 28.

Although an example in which a line type ink jet head is used has been described above, the ink jet recording device according to the present embodiment may be a printer (serial printer) using a serial-type ink jet head. In the serial printer, printing is performed by moving an ink jet head in a direction intersecting the transport direction while transporting a recording medium in the transport direction.

### EXAMPLES

Hereinafter, the present disclosure will be described more specifically with reference to Examples and Comparative Examples. The present disclosure is not limited by the following examples.

### 1. Preparation of Ink Composition

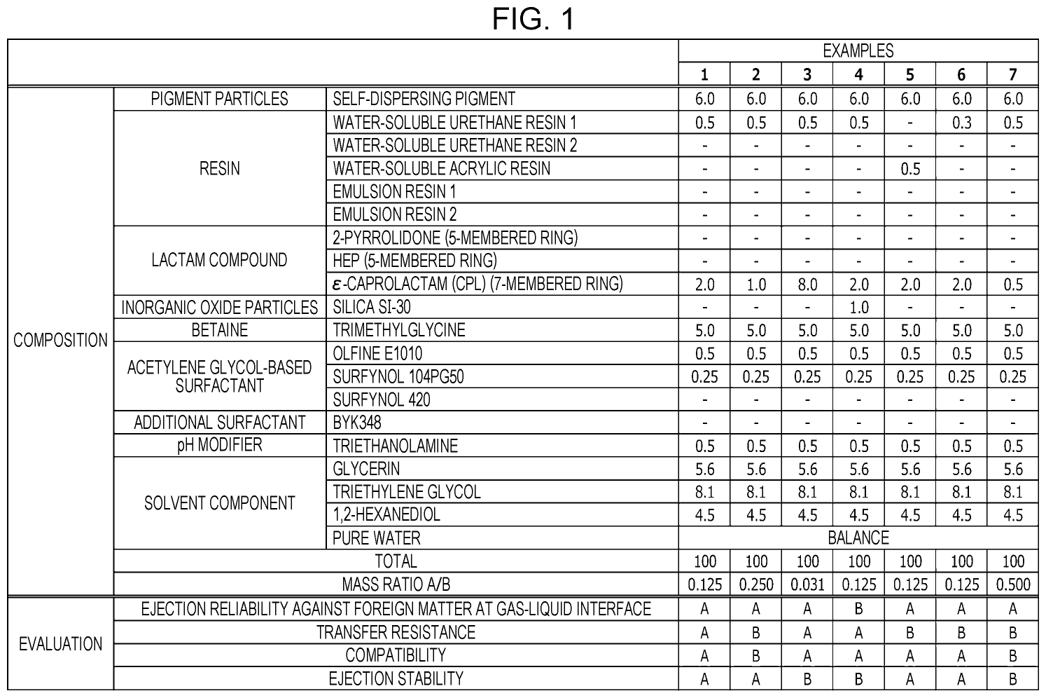

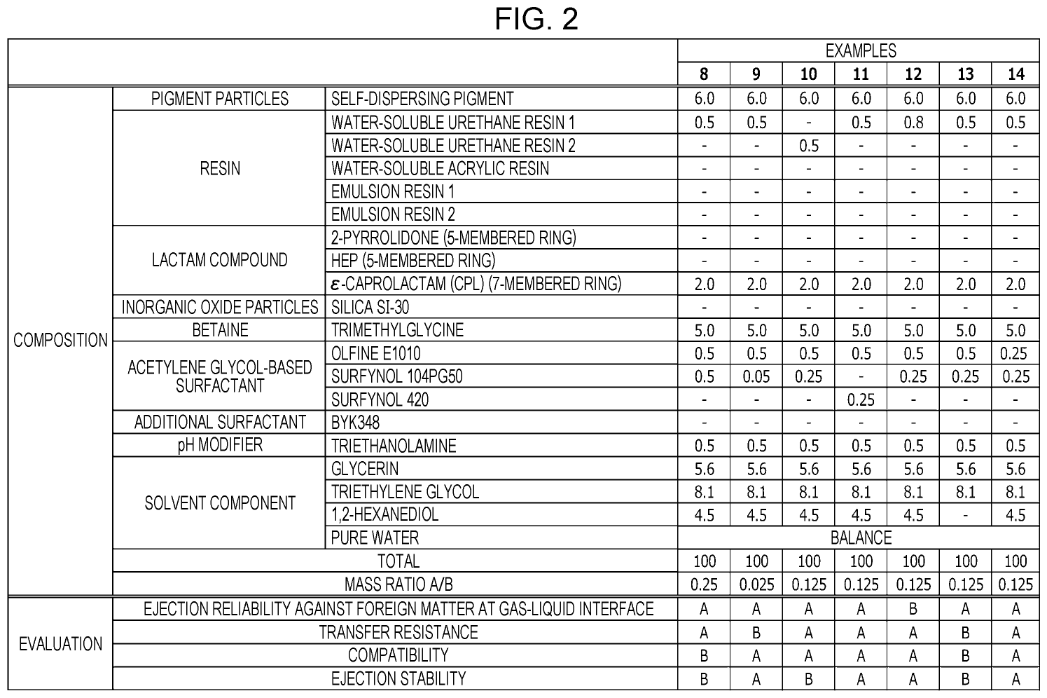

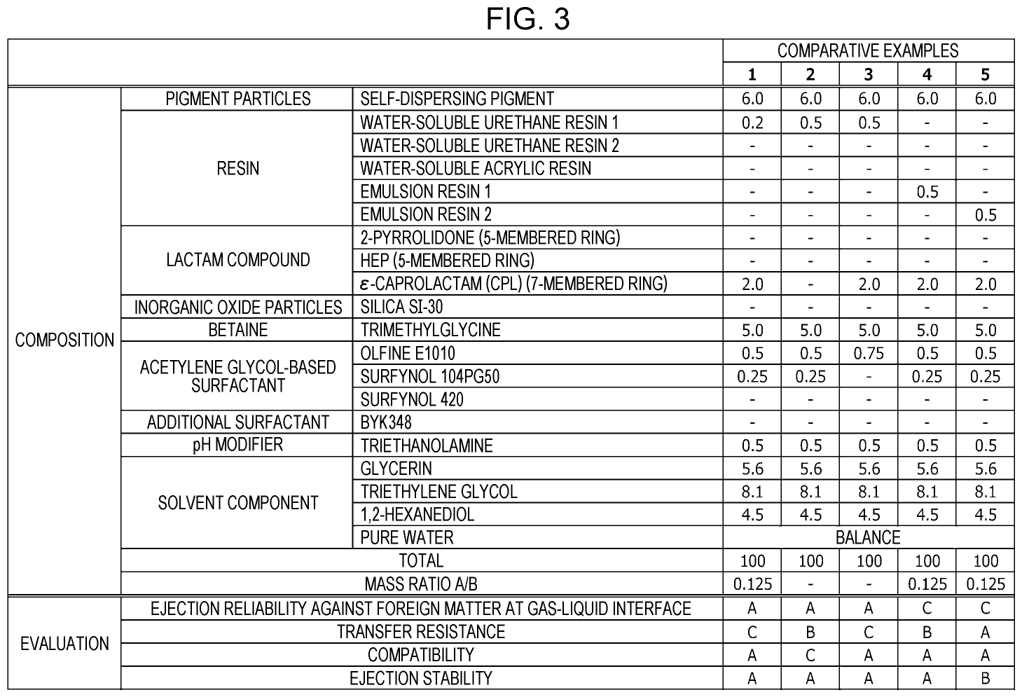

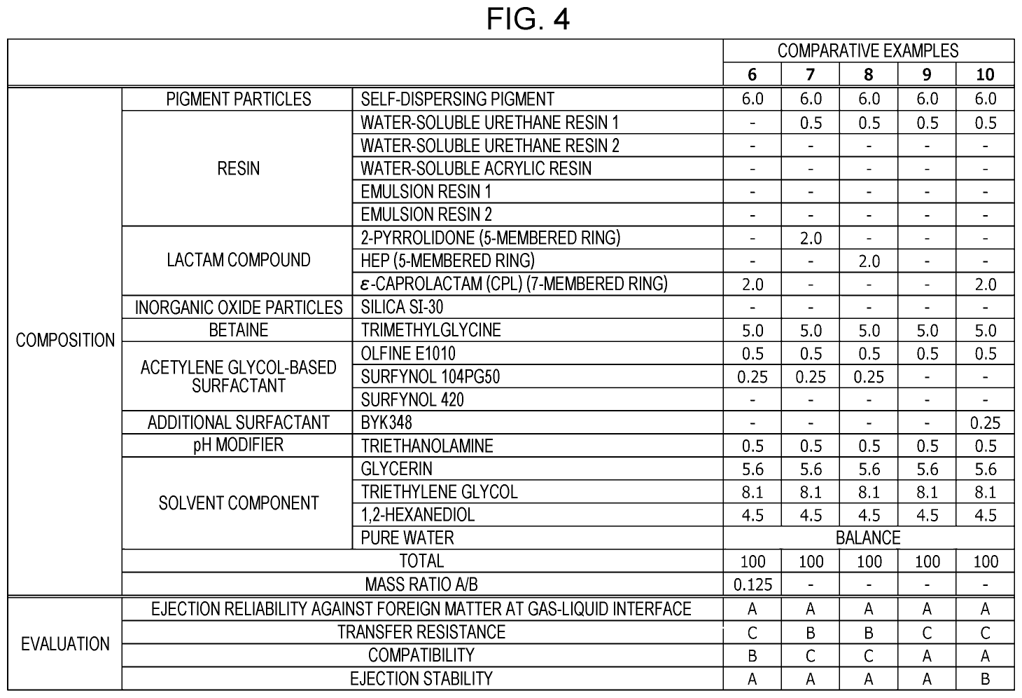

Tables 1 to 4 showing the compositions of ink compositions are described in FIGS. 1 to 4. Each component was put into a mixture tank so as to achieve the compositions shown in Tables 1 to 4, mixed and stirred, and further filtered with a membrane filter to obtain ink jet ink compositions of the respective examples. The numerical value of each component shown in each example in the tables represents mass % unless otherwise specified. In addition, in the tables, the numerical values of the pigment, the inorganic oxide particles, and the resin represent solid contents in terms of mass % of the pigment, the inorganic oxide particles, and the resin, respectively.

The details of the abbreviations and product components used in Tables 1 to 4 are as follows, and the numbers on the right side of the abbreviations of the solvents indicate the SP values of the solvents.
Pigment particles: self-dispersing pigment
CAB-O-JET300 (product name, solid content: 15%, manufactured by Cabot Corporation)

### Resin

Water-soluble urethane resin 1: prepared by the following method. First, a four-necked flask equipped with a stirrer, a thermometer, a nitrogen gas introduction pipe, and a reflux pipe was prepared. Into this four-necked flask were put 41.7 parts by weight of isophorone diisocyanate, 40.1 parts by weight of polypropylene glycol (number average molecular weight: 2,000), 13.2 parts by weight of dimethylolpropionic acid, and 200.0 parts by weight of methyl ethyl ketone, followed by reaction at 80° C. for 6 hours under a nitrogen gas atmosphere (primary reaction). Thereafter, 0.6 parts by weight of ethylenediamine, 2.0 parts by weight of methanol, 2.4 parts by weight of dimethylolpropionic acid, and 100.0 parts by weight of methyl ethyl ketone were added. The residual ratio of isocyanate groups was confirmed by FT-IR, and the reaction was continued at 80° C. until a desired residual ratio was obtained (secondary reaction) to obtain a reaction solution. After the obtained reaction solution was cooled to 40° C., ion-exchanged water was added, and an aqueous potassium hydroxide solution was added while stirring same at high speed with a homomixer. Methyl ethyl ketone was distilled off from the obtained liquid by heating under reduced pressure to obtain a liquid including water-soluble urethane resin 1.

With respect to obtained water-soluble urethane resin 1, hydrochloric acid was added to the liquid including water-soluble urethane resin 1 to precipitate water-soluble urethane resin, the resin was then dried in a vacuum at 40° C. overnight and dissolved in tetrahydrofuran to prepare a sample, and the acid value of water-soluble urethane resin 1 was measured by potentiometric titration using a potassium hydroxide-methanol titration solution and found to be 65 mg KOH/g. The weight average molecular weight of obtained water-soluble urethane resin 1 in terms of polystyrene measured by gel permeation chromatography (GPC) was about 21000.

Water-soluble urethane resin 2: prepared by the following method. Water-soluble urethane resin 2 was prepared in the same manner as in the preparation method for water-soluble urethane resin 1 except that the addition amount of polypropylene glycol was decreased and the addition amount of dimethylolpropionic acid in the primary reaction and the secondary reaction was increased in preparation of water-soluble urethane resin 1. When the acid value and the weight average molecular weight of water-soluble urethane resin 2 were measured by the same measurement method as that for water-soluble urethane resin 1, the acid value and the weight average molecular weight of water-soluble urethane resin 2 were 75 mg KOH/g and about 21000, respectively.

Water-soluble acrylic resin: prepared by the following method. An aqueous solution was obtained by dissolving 20.0 parts of a styrene-acrylic acid copolymer having an acid value of 65 mg KOH/g and a weight average molecular weight of 8,000 in ion-exchanged water using sodium hydroxide in an amount equivalent to the acid value. The obtained aqueous solution was subjected to pressure filtration using a microfilter (manufactured by FUJIFILM Holdings Corporation) having a pore size of 3.0 μm, and an appropriate amount of water was added thereto to prepare a resin aqueous solution. The content of the resin in the aqueous solution was 20.0%.
Emulsion resin 1: X436 (product name, styrene acrylic resin emulsion, Tg: 33° C., acid value: 33 mg KOH/g, manufactured by SEIKO PMC CORPORATION)
Emulsion resin 2: a styrene acrylic resin emulsion was prepared using styrene and an acrylic monomer. Tg was 10° C., and the acid value was 33 mg KOH/g.

### Lactam Compound

HEP (N-hydroxyethylpyrrolidone)
2-Pyrrolidone
ε-Caprolactam

### Inorganic Oxide Particles

Silica SI-30 (product name, manufactured by JGC Catalysts and Chemicals Ltd.)

### Betaine

Trimethylglycine (betaine anhydrous, manufactured by Tokyo Chemical Industry Co., Ltd.)

### Acetylene Glycol-Based Surfactant

OLFINE E1010 (product name, manufactured by Air Products, HLB value: 13 to 14)
SURFYNOL 104PG50 (product name, manufactured by Nissin Chemical Industry Co., Ltd., HLB value: 4)
SURFYNOL 420 (product name, manufactured by Nissin Chemical Industry Co., Ltd., HLB value: 4)

### Additional Surfactant

BYK348 (product name, silicone-based surfactant, manufactured by BYK Japan KK)
pH modifier
Triethanolamine
Solvent component
Glycerin
Triethylene glycol
1,2-Hexanediol

### 2. Evaluation Method

As a recording device, a modified machine of LX-10050 (product name, manufactured by Seiko Epson Corporation), which is a line ink jet printer equipped with a line head, was prepared. In the modified machine, a stainless steel sub-tank was provided between an ink cartridge and a head. The machine was configured such that the continuous ink supply container in FIG. 6 was eliminated, and ink was supplied from the ink cartridge to the head via an ink supply mechanism and an ink flow path. The area of the ink liquid surface (gas-liquid interface) where the ink composition filling the sub-tank was in contact with the air inside was 800 mm². At the time of printing, “Xerox P paper” (manufactured by Fuji Xerox Co., Ltd., basis weight: 64 g/m², paper thickness: 88 μm), which is A4-size copy paper, was used as a recording medium.

### 2. 1. Ejection Reliability Against Foreign Matter at Gas-Liquid Interface

In the above device, after confirming that there were no non-ejecting nozzles, the sub-tank was filled with 40 cc of the ink composition and left to stand at 40° C. for one week. Thereafter, using one head (600 nozzles) of the line head, continuous printing was performed until 40 cc of the ink composition was consumed. At this time, fresh ink that had not been left to stand was supplied to the sub-tank so that the ink did not run out. After printing, 0.5 cc of the ink was suctioned from the nozzles, and the nozzle surfaces were wiped (cleaned) with a rubber wiper. The evaluation was conducted on the basis of the number of cleaning cycles required until no non-ejecting nozzles remained, as described below. When the recording device in which non-ejecting nozzles were observed was examined after the evaluation, foreign matter was observed inside the ink jet head as well as in the sub-tank.

### Evaluation Criteria

A: non-ejecting nozzles were eliminated after performing cleaning three cycles or fewer
B: non-ejecting nozzles were eliminated after performing cleaning four cycles or more and 10 cycles or fewer
C: even after performing cleaning 10 cycles, non-ejecting nozzles remained

### 2. 2. Transfer Resistance

In the environment of a temperature of 25° C. and relative humidity of 50%, solid patterns of 1 cm×1 cm were printed with 1 cm spacing therebetween within a printable area, under the conditions of a print duty of 100%, an ink deposition amount of 4.5 mg/inch², and a print speed of 30 sheets per minute. Printed sheets were discharged face-down and stacked until the total thickness of the stacked paper reached 1 cm. Fresh ink that had not been left to stand was used. The evaluation was conducted on the basis of an ink transfer mark (ink smudge) observed on a side of the stacked paper using the method described below.

### Evaluation Criteria

A: when observed from a distance of 30 cm from the stacked paper, a transfer mark was barely visually observed or was not visually observed
B: when observed from a distance of 30 cm from the stacked paper, a transfer mark was visually observed, but when observed from a distance of 80 cm from the stacked paper, a transfer mark was not visually observed
C: when observed from a distance of 80 cm from the stacked paper, a transfer mark was visually observed

### 2. 3. Compatibility

The ink composition obtained as described above was put into a 100 ml bottle, and the bottle was sealed and left to stand in a thermostatic chamber at 60° C. for 24 hours. Thereafter, the evaluation was conducted on the basis of the occurrence of phase separation or turbidity, according to the following criteria.

### Evaluation Criteria

A: no phase separation into an oil layer and a water layer or turbidity was visually observed
B: no phase separation into an oil layer and a water layer was visually observed, but slight turbidity was observed
C: phase separation into an oil layer and a water layer was visually observed

### 2. 4. Ejection Stability

In the above recording device, after confirming that the nozzle ejection state was normal, the sub-tank was filled with the ink composition obtained as described above, and printing was performed. Fresh ink that had not been left to stand was used. The same test patterns as those for the transfer resistance evaluation was printed, and 30 sheets were printed continuously. After printing, a nozzle check pattern was recorded to confirm whether there was a pattern indicating a non-ejecting nozzle. Furthermore, in a case where no non-ejecting nozzle pattern was observed, ejection stability was evaluated according to the following criteria, where it was determined that an impact position deviation occurred when the impact position deviation in the nozzle check pattern was equal to or greater than 0.5 times the distance between adjacent nozzles. The evaluation was conducted on a single head including 600 nozzles.

### Evaluation Criteria

A: no non-ejecting nozzle or impact position deviation was observed
B: 5 or less non-ejecting nozzles and impact position deviations were observed
C: 6 or more non-ejecting nozzles and impact position deviations were observed

### 3. Evaluation Results

Tables 1 to 4 show the composition and evaluation results of the ink used in each of the examples. From these results, it has been found that an ink jet ink composition that includes a pigment, an acetylene glycol-based surfactant having an HLB value of 5 or less, a lactam compound having a 6- to 8-membered lactam ring, a solvent component, and a water-soluble resin dissolved in the solvent component, in which the content of the water-soluble resin is 0.3% by mass or more based on the total mass of the ink jet ink composition, the solvent component includes water, and the ink jet ink composition is an aqueous ink has excellent ejection reliability, transfer resistance, compatibility, and/or ejection stability.

Although not shown in the tables, when the above-described recording device was modified to a recording device in which ink was supplied from an ink pack to the ink jet head without providing a sub-tank, and evaluation was conducted in the same manner as in Comparative Example 4, ejection reliability against foreign matter at the gas-liquid interface was rated as A. No ink liquid surface (gas-liquid interface) is formed in the ink pack, and no foreign matter was generated. However, it was necessary to interrupt printing immediately after the ink in the ink pack is consumed. The gas-liquid interface foreign matter evaluation was B in a test conducted in the same manner as in Example 1 except that the sub-tank was changed to a sub-tank having an ink liquid surface area of 1000 mm². However, the maximum capacity of the sub-tank increased, and the number of sheets that could be printed with the ink in the sub-tank increased.

What is claimed is:

1. An ink jet ink composition comprising:
a pigment;
an acetylene glycol-based surfactant having an HLB value of 5 or less;
a lactam compound having a 6- to 8-membered lactam ring;
a solvent component; and
a water-soluble resin dissolved in the solvent component, wherein
a content of the water-soluble resin is 0.3% by mass or more based on a total mass of the ink jet ink composition,
the solvent component includes water, and
the ink jet ink composition is an aqueous ink.

2. The ink jet ink composition according to claim 1, wherein
the ink jet ink composition is ejected by an ink jet recording device when used, and
an ink tank to which the ink jet ink composition is supplied in the ink jet recording device or an ink housing body that supplies the ink jet ink composition to the ink jet recording device has a structure in which an ink liquid surface that is a gas-liquid interface between the ink jet ink composition and gas is formed.

3. The ink jet ink composition according to claim 2, wherein
a maximum area of the ink liquid surface is 500 mm² or more.

4. The ink jet ink composition according to claim 1, wherein
a mass ratio (A/B) of a content A of the acetylene glycol-based surfactant to a content B of the lactam compound in the ink jet ink composition is 0.01 or more and 0.7 or less.

5. The ink jet ink composition according to claim 1, wherein
the water-soluble resin includes a urethane-based resin.

6. The ink jet ink composition according to claim 1, wherein
a content of resin particles is less than 0.1% by mass based on a total amount of the ink jet ink composition.

7. The ink jet ink composition according to claim 1, wherein
a content of inorganic oxide particles is less than 0.1% by mass based on a total amount of the ink jet ink composition.

8. The ink jet ink composition according to claim 1, wherein
the pigment includes a self-dispersing pigment.

9. The ink jet ink composition according to claim 1, wherein
the lactam compound includes ε-caprolactam.

10. The ink jet ink composition according to claim 1, wherein
the solvent component includes an alkanediol compound having 5 or more carbon atoms as a water-soluble organic solvent.

11. The ink jet ink composition according to claim 1, wherein
the solvent component includes a polyol having a standard boiling point of 280° C. or higher as a water-soluble organic solvent.

12. The ink jet ink composition according to claim 1, wherein
the ink jet ink composition is used for recording on an absorptive recording medium.

13. An ink jet recording method comprising:
ejecting the ink jet ink composition according to claim 1 from an ink jet head to deposit the ink jet ink composition on a recording medium.

14. The ink jet recording method according to claim 13, wherein
the ink jet head is a line head.

15. An ink jet recording device comprising:
the ink jet ink composition according to claim 1; and
an ink jet head configured to eject the ink jet ink composition.
